(19) United States
(12) Patent Application Publication
(10) Pub. No.: US 2020/0376697 A1
(43) Pub. Date: Dec. 3, 2020

(54) SLIT BLADE BLOCK AND ELECTRIC SHAVER

(71) Applicant: Panasonic Intellectual Property Management Co., Ltd., Osaka (JP)

(72) Inventors: Misaki KONDO, Shiga (JP); Hiroaki SHIMIZU, Shiga (JP); Shoki OKURA, Shiga (JP); Ryo SUZUKI, Shiga (JP)

(21) Appl. No.: 16/883,805

(22) Filed: May 26, 2020

(30) Foreign Application Priority Data
May 31, 2019 (JP) 2019-102174

(51) Int. Cl. B26B 19/42; B26B 19/04

(52) U.S. Cl. CPC B26B 19/42; B26B 19/06; B26B 19/042

(57) ABSTRACT

Slit blade block of an electric shaver of the present disclosure includes a slit outer blade having a plurality of outer blade pieces, a slit inner blade having a plurality of inner blade pieces, and comb provided outside the slit outer blade. Comb has a plurality of protruding portions protruding in a direction away from the slit outer blade. The plurality of protruding portions includes a plurality of types of protruding portions having different shapes. The present disclosure can provide a slit blade block having a comb that scoops lying long facial hair more easily, and an electric shaver provided with the slit blade block.

### BACKGROUND

### 1. Technical Field

The present disclosure relates to a slit blade block having a structure for roughly shaving facial hair of a certain length (hereinafter, referred to as “long facial hair”), curling facial hair, and the like, and an electric shaver including the slit blade block.

### 2. Description of the Related Art

A slit blade block includes a slit outer blade, a slit inner blade, and a comb. The slit outer blade includes a large number of outer blade pieces. The slit inner blade includes a large number of inner blade pieces. The slit inner blade, in a state of being accommodated in the slit outer blade, reciprocates with respect to the slit outer blade. The comb accommodates the slit outer blade and the slit inner blade. The comb has a large number of protruding portions protruding in a direction away from the slit outer blade. The large number of the protruding portions have a single shape.

Japanese Patent No. 6376427 shows an example of a conventional slit blade block.

### SUMMARY

A slit blade block aims to roughly shave facial hair, that is, to cut long facial hair into short facial hair. In such a slit blade block, when an interval between outer blade pieces of the slit outer blade is increased in order to improve the ease of taking in hair into the slit blade block (hereinafter, referred to as “introducibility of hair”), irritation to the skin is increased. When the width of a crosspiece between the outer blade pieces is made to be thin without changing the interval between the outer blade pieces, the strength of the slit outer blade is deteriorated.

In order to improve the introducibility of hair without changing the interval between the outer blade pieces of the slit outer blade, the slit blade block is provided with a comb. When a top of a protruding portion in the comb is inserted between lying long facial hair and the skin, the long facial hair rides on the top of the protruding portion. As the comb moves, the long facial hair rises along the surface of the protruding portion. In the state, the long facial hair is introduced into the slit blade block.

However, in the conventional slit blade block, the protruding portions formed on the tip of the comb have a single shape. Therefore, all the long facial hair cannot be introduced into the slit blade block, leaving some facial hair unshaved.

The present disclosure aims to provide a slit blade block allowing a comb to scoop long facial hair more easily, and an electric shaver including the slit blade block.

A slit blade block according to one aspect of the present disclosure includes a slit outer blade having a plurality of outer blade pieces, a slit inner blade having a plurality of inner blade pieces, and a comb provided outside the slit outer blade. The comb has a plurality of protruding portions protruding in a direction away from the slit outer blade. The plurality of protruding portions has a plurality of types of protruding portions having different shapes.

An electric shaver according to another aspect of the present disclosure includes the slit blade block of the above-mentioned aspect.

The present disclosure can provide a slit blade block that scoops lying long facial hair more easily, and an electric shaver including the slit blade block.

### BRIEF DESCRIPTION OF DRAWINGS

FIG. 1 is an exploded perspective view of an electric shaver in accordance with an exemplary embodiment of the present disclosure.

FIG. 2 is an exploded perspective view of a slit blade block in accordance with the exemplary embodiment.

FIG. 3 is a front view of the slit blade block in accordance with the exemplary embodiment.

FIG. 4 is a plan view of the slit blade block in accordance with the exemplary embodiment.

FIG. 5 is a plan view showing a structure of a comb component and the periphery thereof in accordance with the exemplary embodiment.

FIG. 6 is a sectional view of the slit blade block taken along line 6-6 of FIG. 4 in accordance with the exemplary embodiment.

FIG. 7 is a sectional view schematically showing a tip of the comb in accordance with the exemplary embodiment.

FIG. 8A is a perspective view of a portion of the comb in accordance with the exemplary embodiment.

FIG. 8B is a perspective view of a portion of the comb in accordance with the exemplary embodiment.

FIG. 8C is a perspective view of a portion of the comb in accordance with the exemplary embodiment.

FIG. 9 is a sectional view schematically showing a tip of a comb in accordance with a first modified example of the exemplary embodiment.

FIG. 10 is a sectional view schematically showing a tip of a comb in accordance with a second modified example of the exemplary embodiment.

FIG. 11 is a plan view showing a structure of a slit blade block in accordance with a third modified example of the exemplary embodiment.

FIG. 12 is a plan view showing a structure of a slit blade block in accordance with a fourth modified example of the exemplary embodiment.

### DETAILED DESCRIPTION OF PREFERRED EMBODIMENTS

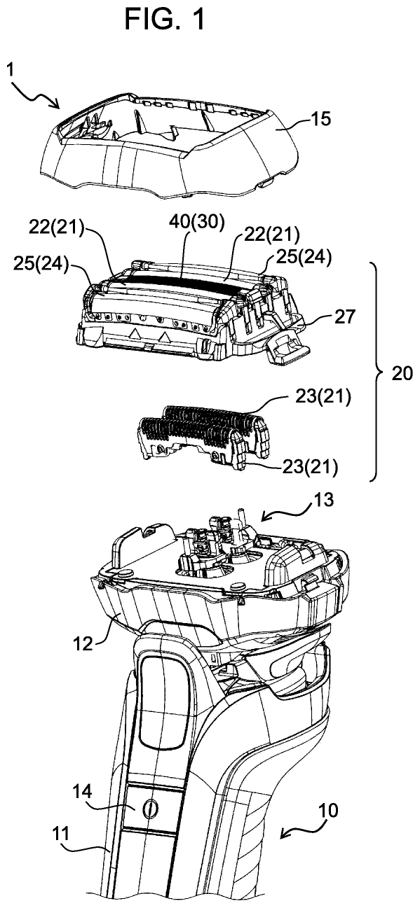

FIG. 1 is an exploded perspective view of electric shaver 1 in accordance with an exemplary embodiment of the present disclosure. A configuration of electric shaver 1 is described with reference to FIG. 1. As shown in FIG. 1, electric shaver 1 includes shaver body 10 and blade unit 20.

Shaver body 10 includes grip 11, head 12, driving unit 13, power supply switch 14, and head cover 15. Head 12 is bonded to grip 11. Driving unit 13 is accommodated in grip 11 and head 12. A portion of driving unit 13 protrudes toward the outside from head 12. Driving unit 13 allows blade unit 20 to reciprocate. Power supply switch 14 is placed on grip 11.

Head cover 15 is attached to head 12, and covers an outer periphery of blade unit 20. Blade unit 20 includes two first blade blocks 21, two second blade blocks 24, slit blade block 30, and outer blade case 27.

Two first blade blocks 21 are placed in parallel to slit blade block 30 so as to sandwich slit blade block 30. Two second blade blocks 24 are placed in parallel to two first blade blocks 21 so as to sandwich two first blade blocks 21.

Outer blade case 27 holds two first blade blocks 21, two second blade blocks 24, and slit blade block 30. Outer blade case 27 is attached to head 12.

First blade blocks 21 include first net blade 22 and first inner blade 23. First net blade 22 accommodates first inner blade 23. Driving unit 13 allows first inner blade 23 to reciprocate with respect to first net blade 22.

Second blade blocks 24 include second net blade 25 and a second inner blade (not shown). Second net blade 25 accommodates the second inner blade. Driving unit 13 allows the second inner blade to reciprocate with respect to second net blade 25. In this way, electric shaver 1 is a reciprocating electric shaver that allows first inner blade 23 and the second inner blade to reciprocate with respect to first net blade 22 and second net blade 25, respectively.

Functions of blade unit 20 are described.

First blade blocks 21 mainly cut out lying facial hair. Second blade blocks 24 mainly cut out standing short facial hair. Slit blade block 30 mainly cuts out thin long facial hair.

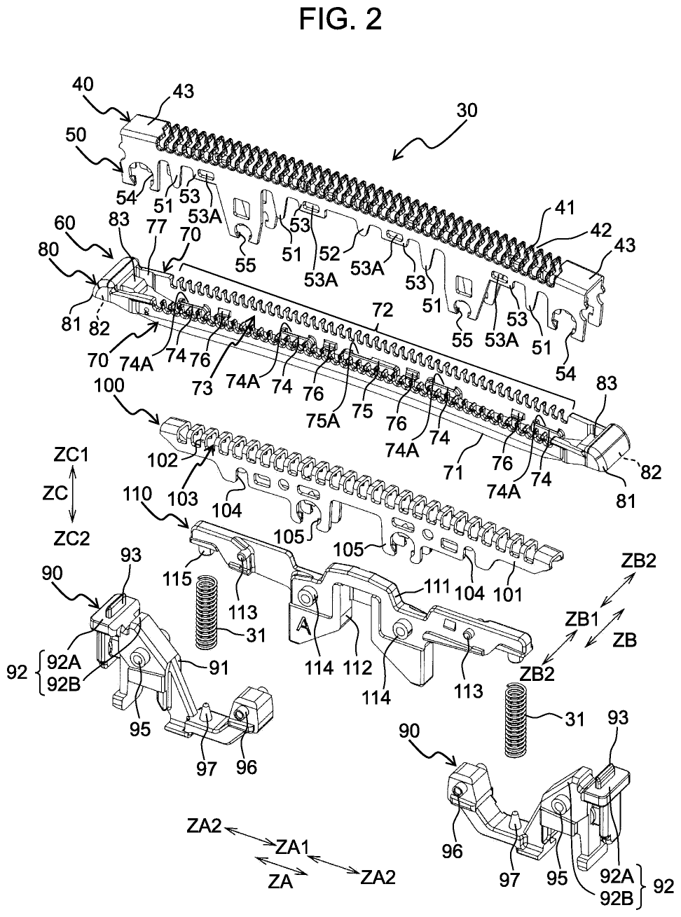

FIG. 2 is an exploded perspective view of slit blade block 30. A detailed configuration of slit blade block 30 is described with reference to FIG. 2.

As shown in FIG. 2, directions with respect to slit blade block 30 include a width direction ZA, an inner width direction ZA1, an outer width direction ZA2, a depth direction ZB, an inner depth direction ZB1, an outer depth direction ZB2, a height direction ZC, a tip direction ZC1, and a base direction ZC2, which are defined as follows.

The width direction ZA is a longitudinal direction in the front view of slit blade block 30. The width direction ZA includes inner width direction ZA1 and outer width direction ZA2. The inner width direction ZA1 in the width direction ZA is a direction toward the center of the width direction ZA. The outer width direction ZA2 in the width direction ZA is a direction away from the center of the width direction ZA.

The height direction ZC is a direction orthogonal to the width direction ZA in the front view of slit blade block 30. The height direction ZC includes a tip direction ZC1 and a base direction ZC2. The tip direction ZC1 is a direction from shaver body 10 toward blade unit 20 (see FIG. 1) in the height direction ZC. The base direction ZC2 is a direction from blade unit 20 toward shaver body 10 in the height direction ZC.

The depth direction ZB is a direction orthogonal to width direction ZA and height direction ZC. The depth direction ZB includes the inner depth direction ZB1 and the outer depth direction ZB2. The inner depth direction ZB1 in the depth direction ZB is a direction toward the center of the depth direction ZB. The outer depth direction ZB2 in the depth direction ZB is a direction away from the center of the depth direction ZB.

Slit blade block 30 includes slit outer blade 40, comb component 60, two outer blade joints 90, slit inner blade 100, inner blade joint 110, and two coil springs 31. Inner blade joint 110 is connected to driving unit 13 (see FIG. 1).

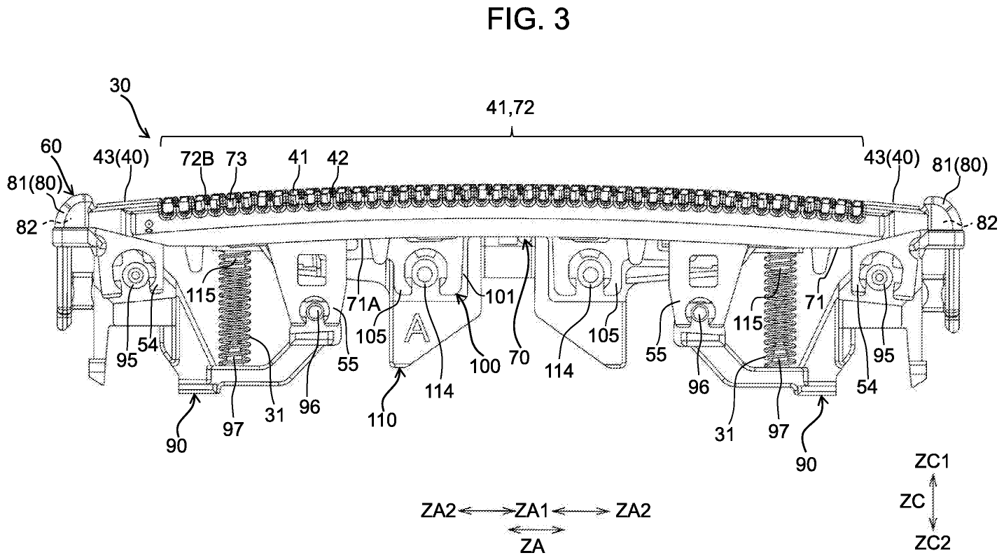

Slit outer blade 40 is formed by, for example, pressing a metal material. Slit outer blade 40, as a whole, has a gently curved shape that is curved in the tip direction ZC1 toward the middle of the width direction ZA in the front view (see FIG. 3). Slit outer blade 40, as a whole, has a U-shape that opens in the base direction ZC2 in the side view.

Slit outer blade 40 includes a large number of outer blade pieces 41, a large number of slit holes 42, two linking parts 43, and two slit main body parts 50. Slit outer blade 40 is made by unitarily forming the large number of outer blade pieces 41, two linking parts 43, and two slit main body parts 50 with the same material.

Comb component 60 is formed separately from slit outer blade 40. Comb component 60 is formed by, for example, injection-molding a resin material. Comb component 60 has a frame shape in a plan view. Comb component 60, as a whole, has a gently curved shape that is curved in the tip direction ZC1 toward the center of the width direction ZA in a front view.

Comb component 60 has lower rigidity than slit outer blade 40. Comb component 60 has two comb supporting walls 70 and two comb end walls 80. Comb component 60 is made by unitarily forming two comb supporting walls 70 and two comb end walls 80 with the same material.

Two outer blade joints 90 are formed by, for example, injection-molding a resin material. Two outer blade joints 90 are placed away from each other in the width direction ZA. Each of two outer blade joints 90 includes joint main body 91, mount part 92, protruding portion 93, four first welding parts 95, four second welding parts 96, and spring attachment part 97.

Each of two outer blade joints 90 is made by unitarily forming joint main body 91, mount part 92, protruding portion 93, four first welding parts 95, four second welding parts 96, and spring attachment part 97 with the same material.

Slit inner blade 100 is formed by, for example, pressing a metal material. Slit inner blade 100 includes two slit main body parts 101, a large number of inner blade pieces 102, and a large number of slit holes 103. Slit inner blade 100 is made by unitarily forming two slit main body parts 101 and a large number of inner blade pieces 102 with the same material.

Each of two slit main body parts 101 includes two positioning parts 104 and two weld fixing parts 105. Two slit main body parts 101 are coupled to each other by a large number of inner blade pieces 102, respectively. Each positioning part 104 has a recess that opens in the base direction ZC2. Each positioning part 104 is displaced toward the outer width direction ZA2 from the center in the width direction ZA of slit main body part 101.

Each weld fixing part 105 has a pair of arms away from each other in the width direction ZA. Each arm extends in the base direction ZC2. Each weld fixing part 105 is placed in such a manner that it is displaced in the inner width direction ZA1 from each positioning part 104.

Each of the large number of inner blade pieces 102 has a U-shape that opens in the base direction ZC2. The large number of inner blade pieces 102 are placed at equal intervals in the width direction ZA. Slit hole 103 is a gap between two inner blade pieces 102 adjacent to each other in the width direction ZA.

Inner blade joint 110 is formed by, for example, injection-molding a resin material. The inner blade joint 110 includes joint main body 111, drive fitting part 112, four positioning parts 113, four welding parts 114, and two spring attachment parts 115. Inner blade joint 110 is made by unitarily forming joint main body 111, drive fitting part 112, four positioning parts 113, four welding parts 114, and two spring attachment parts 115 with the same material.

Joint main body 111 includes drive fitting part 112 provided in the middle of the width direction ZA and recessed in the tip direction ZC1. Driving unit 13 (see FIG. 1) is to be fitted into drive fitting part 112.

Each positioning part 113 is placed in a position displaced from the center of joint main body 111 toward the outer width direction ZA2 so as to protrude in the outer depth direction ZB2. Each welding part 114 is placed so as to protrude in the outer depth direction ZB2 in a position displaced from each positioning part 113 toward the inner width direction ZA1. Each spring attachment part 115 is placed at the end portion in the outer width direction ZA2 so as to protrude in the base direction ZC2 of joint main body 111.

A detailed configuration of slit outer blade 40 is described with reference to FIG. 2.

Each of the large number of outer blade pieces 41 has a U-shape that opens in the base direction ZC2 in a side view. The large number of outer blade pieces 41 are placed at equal intervals between two linking parts 43 in the width direction ZA.

Slit hole 42 is a gap between two outer blade pieces 41 adjacent to each other in the width direction ZA. Slit hole 42 has space penetrating through slit outer blade 40 in the depth direction ZB. Slit hole 42 introduces facial hair into the inside of slit outer blade 40.

Each of two linking parts 43 has a flat-plate shape in a plan view. Each of two linking parts 43 has a gently curved shape that is curved in the tip direction ZC1 toward the inner width direction ZA1. Two linking parts 43 are placed one by one at both ends of slit outer blade 40 in the width direction ZA.

Each of two slit main body parts 50 has a wall portion perpendicular to the depth direction ZB. Each of two slit main body parts 50 includes four first claw pieces 51, one second claw piece 52, four fitting parts 53, two first weld fixing parts 54, and two second weld fixing parts 55. Two slit main body parts 50 are coupled to each other by a large number of outer blade pieces 41 and two linking parts 43.

One of two first weld fixing parts 54 is placed at one of the two end portions in the width direction ZA of slit main body part 50. The other of two first weld fixing parts 54 is placed at the other of the two end portions in the width direction ZA of slit main body part 50.

One of two second weld fixing parts 55 is placed in a position displaced from one of two first weld fixing parts 54 of slit main body part 50 toward the inner width direction ZA1. The other of two second weld fixing parts 55 is placed in a position displaced from the other of two first weld fixing parts 54 toward the inner width direction ZA1 in slit main body part 50.

Each of four first claw piece 51 has a tapered shape in which the dimension in the width direction ZA decreases toward the base direction ZC2. A tip part of each of four first claw pieces 51 has a curved shape in a front view. Four first claw pieces 51 are placed such that they are away from each other in the width direction ZA.

One of four first claw pieces 51 is placed between one of two first weld fixing parts 54 and one of two second weld fixing parts 55. One of the remaining first claw pieces 51 is placed between the other of two first weld fixing parts 54 and the other of two second weld fixing parts 55.

One of the remaining two first claw pieces 51 is placed in a position displaced from one of two second weld fixing parts 55 of slit main body part 50 toward the inner width direction ZA1. The other of the remaining two first claw pieces 51 is placed in a position displaced from the other of two second weld fixing parts 55 of slit main body part 50 toward the inner width direction ZA1.

Second claw piece 52 has a tapered shape in which the dimension in the width direction ZA decreases toward the base direction ZC2. A tip part of second claw piece 52 has a curved shape in a front view. Second claw piece 52 is placed in the middle in the width direction ZA of slit main body part 50. Second claw piece 52 has a smaller dimension in the height direction ZC than two first claw pieces 51.

Four fitting parts 53 are placed away from each other in the width direction ZA. One of four fitting parts 53 is adjacent to one of two second weld fixing parts 55 in the outer width direction ZA2. The one of remaining three fitting parts 53 is adjacent to the other of two second weld fixing parts 55 in the outer width direction ZA2.

One of the remaining two fitting parts 53 is adjacent to first claw piece 51 closest to one of two second weld fixing parts 55 in the inner width direction ZA1. The other of the remaining two fitting parts 53 is adjacent to first claw piece 51 closest to the other of two second weld fixing parts 55 in the inner width direction ZA1. Each of four fitting parts 53 has through-hole 53A penetrating through slit main body part 50 in the depth direction ZB.

A detailed configuration of each of two outer blade joints 90 is described with reference to FIG. 2.

Mount part 92 has a T-shape in a plan view. Mount part 92 is placed at the end portion in the outer width direction ZA2 and the tip direction ZC1 of joint main body 91. Mount part 92 includes outer mount part 92A and inner mount part 92B. Outer mount part 92A is formed in continuous with inner mount part 92B in the outer width direction ZA2. Outer mount part 92A has a larger dimension in the depth direction ZB than inner mount part 92B.

Protruding portion 93 has a rectangular shape having a larger dimension in the depth direction ZB than in the width direction ZA in a plan view. Protruding portion 93 is placed on outer mount part 92A of mount part 92 so as to protrude in the tip direction ZC1.

First welding part 95 and second welding part 96 have a cylindrical shape. First welding part 95 is placed closer to mount part 92 than second welding part 96 of joint main body 91. First welding part 95 is placed on a surface of joint main body 91, orthogonal to the depth direction ZB, so as to protrude in the outer depth direction ZB2.

Second welding part 96 is placed at the end portion in the inner width direction ZA1 of joint main body 91. Second welding part 96 is placed on a surface orthogonal to the depth direction ZB of joint main body 91 so as to protrude in the outer depth direction ZB2.

Spring attachment part 97 is placed in a portion between first welding part 95 and second welding part 96 in joint main body 91. Spring attachment part 97 is a substantially conical shaped protrusion placed on joint main body 91 so as to protrude in the tip direction ZC1.

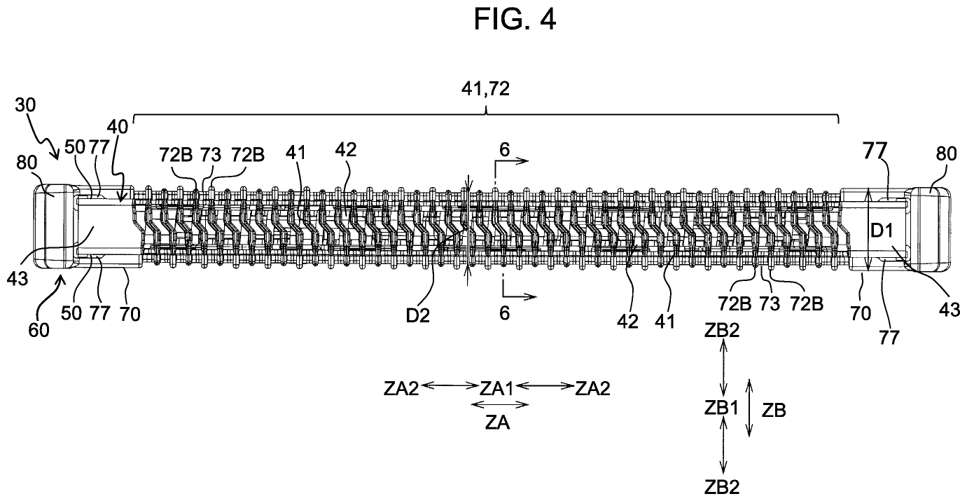

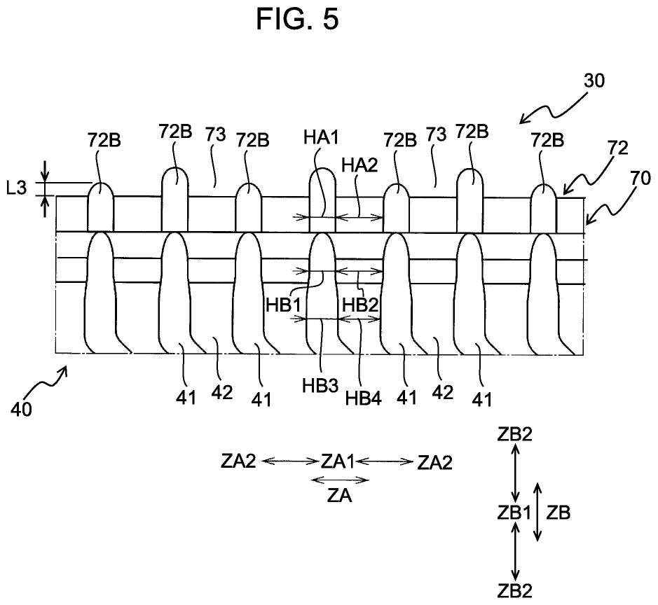

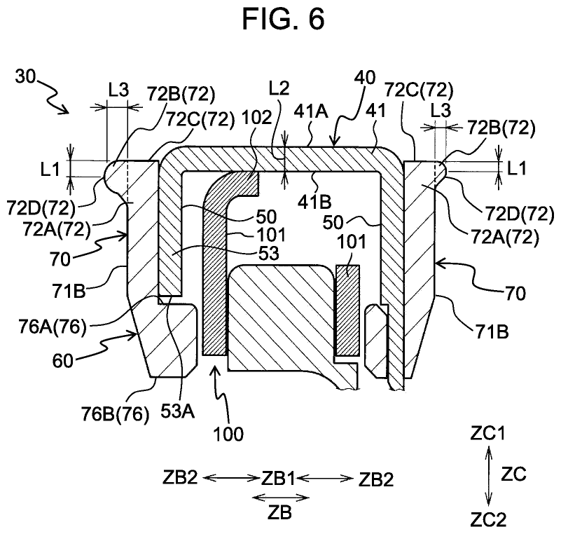

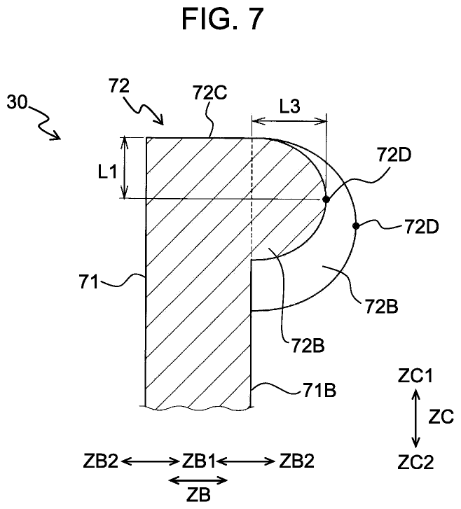

FIGS. 3 and 4 are a front view and a plan view of slit blade block 30, respectively. FIG. 5 is a plan view showing a structure of comb component 60 and the peripheral portions thereof. FIG. 6 is a sectional view of slit blade block 30 taken along line 6-6 of FIG. 4. FIG. 7 is a sectional view schematically showing a tip of comb 72. A detailed description of comb component 60 is described with reference to these drawings.

As shown in FIG. 4, in comb component 60, D1 represents a dimension in the depth direction ZB of each of two comb supporting walls 70. D2 represents a dimension in the depth direction ZB in the middle in the width direction ZA of slit blade block 30. In this exemplary embodiment, the dimension D1 is larger than the dimension D2.

As shown in FIGS. 2 and 3, each of two comb supporting walls 70 includes supporting wall main body 71, two combs 72, a large number of slit holes 73, four first accommodation parts 74, second accommodation part 75, four positioning parts 76, and two stepped portions 77. Each of two comb supporting walls 70 is made by unitarily forming supporting wall main body 71, two combs 72, four first accommodation parts 74, one second accommodation part 75, four positioning parts 76, and two stepped portions 77 with the same material.

Supporting wall main body 71 is in parallel to the width direction ZA and the depth direction ZB. Each supporting wall main body 71, as a whole, has a gently curved shape that is curved in the tip direction ZC1 toward the center of the width direction ZA in a front view.

Each of two combs 72 has a large number of comb-teeth arranged at equal intervals in the width direction ZA. At a tip of each of the large number of comb-teeth, protruding portion 72B is provided. Comb 72 is placed at the end portion in the tip direction ZC1 of supporting wall main body 71.

Comb 72 includes two types of protruding portions 72B having different shapes (see FIGS. 5 and 7). However, this exemplary embodiment is not limited to this. Comb 72 may include three types or more of protruding portions 72B having different shapes.

As shown in FIG. 6, comb 72 includes support part 72A, protruding portion 72B, tip surface 72C, and top 72D. Comb 72 is made by unitarily forming support part 72A, protruding portion 72B, tip surface 72C, and top 72D with the same material.

Support part 72A is a columnar member extending in the height direction ZC. Protruding portion 72B has a round shape in a side view from the width direction ZA, that is, in a state shown in FIG. 6. Protruding portion 72B is provided in the vicinity of the end portion in the tip direction ZC1 of support part 72A so as to protrude in the outer depth direction ZB2. Tip surface 72C is a surface perpendicular to the height direction ZC and provided to the end portion in the tip direction ZC1 of support part 72A. Top 72D is the most protruding portion in the outer depth direction ZB2 of protruding portion 72B.

As shown in FIGS. 6 and 7, in slit blade block 30, two adjacent protruding portions 72B of comb 72 have a different distance between tip surface 72C and top 72D, that is, a different height dimension L1. In other words, the height dimension L1 of protruding portion 72B is a distance between tip surface 72C and top 72D in the height direction ZC.

In slit blade block 30, two adjacent protruding portions 72B of comb 72 have different distances between side surface 71B and top 72D, that is, different protruding dimensions L3. In other words, protruding dimension L3 of protruding portion 72B is a distance between side surface 71B and top 72D in the depth direction ZB.

In slit blade block 30, protruding dimension L3 is larger than the height dimension L1. Protruding portion 72B having smaller protruding dimension L3 has smaller height dimension L1 of protruding portion 72B than protruding portion 72B having larger protruding dimension L3. Protruding dimension L3 of protruding portion 72B having smaller protruding dimension L3 is larger than height dimension L1 of protruding portion 72B having smaller protruding dimension L3.

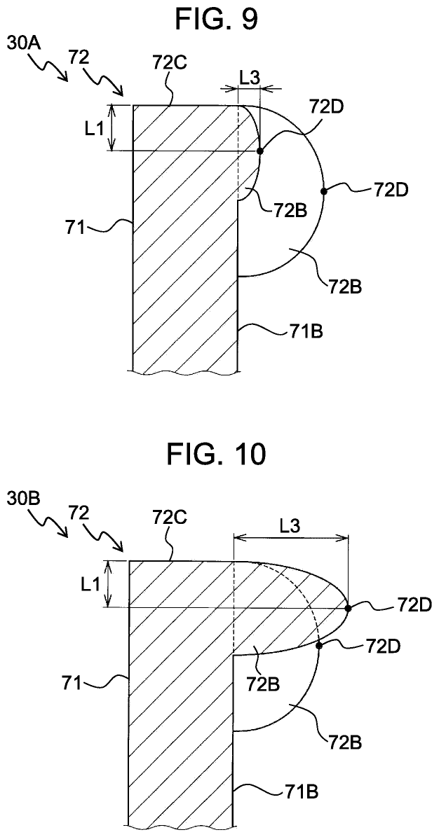

FIG. 9 is a sectional view schematically showing a tip of comb 72 of slit blade block 30A in accordance with a first modified example of the exemplary embodiment. FIG. 10 is a sectional view schematically showing a tip of comb 72 of slit blade block 30B in accordance with a second modified example of the exemplary embodiment.

As shown in FIG. 9, in slit blade block 30A, protruding portion 72B having smaller protruding dimension L3 has smaller protruding dimension L3 than protruding portion 72B having smaller protruding dimension L3 shown in FIG. 7. Protruding dimension L3 of protruding portion 72B having smaller protruding dimension L3 is smaller than height dimension L1 of protruding portion 72B having larger protruding dimension L3.

As shown in FIG. 10, in slit blade block 30B, protruding portion 72B having larger protruding dimension L3 has larger protruding dimension L3 than protruding portion 72B having larger protruding dimension L3 shown in FIG. 7. Height dimension L1 of protruding portion 72B having smaller protruding dimension L3 is larger than height dimension L1 of protruding portion 72B having larger protruding dimension L3.

As shown in FIG. 3, slit hole 73 is a gap between two protruding portions 72B adjacent to each other in the width direction ZA. Slit hole 73 introduces long facial hair into slit hole 42 of slit outer blade 40 (see FIG. 2).

As shown in FIG. 2, four first accommodation parts 74 are provided to supporting wall main body 71 so as to protrude in the tip direction ZC1. Four first accommodation parts 74 are away from each other in the width direction ZA. One of four first accommodation parts 74 is placed at one end portion of supporting wall main body 71 in the width direction ZA. One of the remaining first accommodation parts 74 is placed at the other end portion in the width direction ZA of supporting wall main body 71. Each of four first accommodation parts 74 has through-hole 74A penetrating in the height direction ZC.

Second accommodation part 75 is provided in the middle in the width direction ZA of supporting wall main body 71 so as to protrude in the inner depth direction ZB1. Second accommodation part 75 has through-hole 75A penetrating in the height direction ZC. Second accommodation part 75 has a larger dimension in the width direction ZA than first accommodation part 74.

Two comb end walls 80 are provided one by one on both ends in the width direction ZA of supporting wall main body 71. One of two stepped portions 77 is adjacent to one of two comb end walls 80. The other of two stepped portions 77 is adjacent to the other of two comb end walls 80. Each of two stepped portions 77 has a shape in which the surface inside comb supporting wall 70 is recessed in the outer depth direction ZB2.

Four positioning parts 76 are provided to supporting wall main body 71 so as to protrude in the inner depth direction ZB1. Four positioning parts 76 are away from each other in the width direction ZA. Two of four positioning parts 76 are placed one by one in a position displaced from each of the outer two of four first accommodation parts 74 toward the inner width direction ZA1. Two remaining positioning parts 76 are placed one by one in a position displaced from each of the inner two of four first accommodation parts 74 toward the inner width direction ZA1.

As shown in FIG. 6, each of four positioning parts 76 has upper regulating surface 76A and lower regulating surface 76B. Upper regulating surface 76A is a plane formed as an end surface of the tip direction ZC1 and being perpendicular to the height direction ZC. Lower regulating surface 76B is a plane formed as an end surface of the base direction ZC2 and being perpendicular to the height direction ZC.

As shown in FIG. 2, comb end wall 80 includes end wall main body 81, accommodation part 82, and protruding portion 83. Comb end wall 80 is made by unitarily forming end wall main body 81 and protruding portion 83 with the same material. Comb end wall 80 is coupled to the end portions in the width direction ZA of supporting wall main body 71 at the end portions in the depth direction ZB of end wall main body 81.

As shown in FIG. 3, end wall main body 81, as a whole, has a curved shape that is curved in the base direction ZC2 toward the outer width direction ZA2 in a front view. End portion in the tip direction ZC1 of end wall main body 81 is positioned in the tip direction ZC1 with respect to the end portion in the tip direction ZC1 of supporting wall main body 71. Accommodation part 82 is a recess provided in the end surface of base direction ZC2 of end wall main body 81 and recessed in the tip direction ZC1.

As shown in FIG. 2, protruding portion 83 has a quadrangular shape in a plan view. Protruding portion 83 protrudes from the inner end surface of end wall main body 81 toward the inner width direction ZA1. Protruding portion 83 has a plane perpendicular to the height direction ZC. Protruding portion 83 faces step difference portion 77 of comb supporting wall 70 in the depth direction ZB. When injection-molding is carried out, a gate for pouring a material into a mold is placed on the end surface in the base direction ZC2 of protruding portion 83.

A configuration of slit blade block 30 after assembly is described with reference to FIGS. 3 and 4.

As shown in FIGS. 3 and 4, slit blade block 30 is made by bonding slit outer blade 40, comb component 60, outer blade joints 90, slit inner blade 100, inner blade joint 110, and coil springs 31 together.

When slit blade block 30 is made, first weld fixing part 54 and second weld fixing part 55 of slit outer blade 40 are positioned in the base direction ZC2 with respect to the end surface in the base direction ZC2 (hereinafter, referred to as a base surface) of supporting wall main body 71. The same is true to first welding part 95 and second welding part 96 of outer blade joint 90. Weld fixing part 105 of slit inner blade 100 is positioned in the base direction ZC2 with respect to the base surface of supporting wall main body 71. The same is true to welding part 114 of inner blade joint 110.

First welding part 95 of outer blade joint 90 is positioned inside first weld fixing part 54 of slit outer blade 40. First welding part 95 is welded to first weld fixing part 54 by heat sealing. Second welding part 96 of outer blade joint 90 is positioned inside second weld fixing part 55 of slit outer blade 40. Second welding part 96 is welded to second weld fixing part 55 by heat sealing. Thus, outer blade joint 90 is bonded to slit outer blade 40.

Inner blade joint 110 is accommodated between two slit main body parts 101 of slit inner blade 100. When positioning part 113 (see FIG. 2) is fitted into positioning part 104 (see FIG. 2) of slit inner blade 100, inner blade joint 110 is positioned with respect to slit inner blade 100. Welding part 114 is welded to weld fixing part 105 by heat sealing. Thus, inner blade joint 110 is bonded to slit inner blade 100.

Slit outer blade 40 accommodates slit inner blade 100. A large number of inner blade pieces 102 (see FIG. 2) are positioned in the same positions as a large number of outer blade pieces 41, respectively, in the width direction ZA and the depth direction ZB. The large number of inner blade pieces 102 are positioned in the base direction ZC2 to the large number of outer blade pieces 41, respectively. With this configuration, a direction from the large number of inner blade pieces 102 to the large number of outer blade pieces 41 coincides with the tip direction ZC1.

Slit blade block 30 is made by linking inner blade joint 110 and outer blade joint 90 by coil spring 31. The end portion in the tip direction ZC1 of coil spring 31 is fitted into spring attachment part 115 of inner blade joint 110. The end portion in the base direction ZC2 of coil spring 31 is fitted into spring attachment part 97 of outer blade joint 90. When slit blade block 30 is made, coil spring 31 is compressed by inner blade joint 110 and outer blade joint 90.

As shown in FIG. 4, comb component 60 surrounds slit outer blade 40. An arrangement pitch of a plurality of comb-teeth provided in comb 72 is equal to the arrangement pitch of the large number of outer blade pieces 41. Positions of the plurality of comb-teeth provided to comb 72 in the width direction ZA are the same as the positions in the width direction ZA at the ends in the depth direction ZB of the large number of outer blade pieces 41, respectively. Therefore, each of the large number of slit holes 73 of comb component 60 communicate with one of the large number of corresponding slit holes 42 of slit outer blade 40.

Comb supporting wall 70 faces slit main body part 50 of slit outer blade 40 in the depth direction ZB (see FIG. 2) over substantially the entire width direction ZA. Comb supporting wall 70, at end portions in the width direction ZA, faces a surface in the outer depth direction ZB2 of slit main body part 50 via a gap provided to step difference portion 77.

As shown in FIG. 5, dimension HA1 in the width direction ZA of protruding portion 72B is equal to dimension HB1 in the width direction ZA at the end portion in the outer depth direction ZB2 of each of the large number of outer blade pieces 41 in a plan view. Therefore, dimension HA2 in the width direction ZA of slit hole 73 is equal to dimension HB2 in the width direction ZA of slit hole 42 at the end portion in the outer depth direction ZB2 of slit outer blade 40 in a plan view.

Dimension HA1 in the width direction ZA of protruding portion 72B is smaller than dimension HB3 in the width direction ZA in the middle in the depth direction ZB of each of the large number of outer blade pieces 41 in a plan view. Therefore, dimension HA2 in the width direction ZA of slit hole 73 is larger than dimension HB4 in the width direction ZA of slit hole 42 in the middle in depth direction ZB of slit outer blade 40 in a plan view.

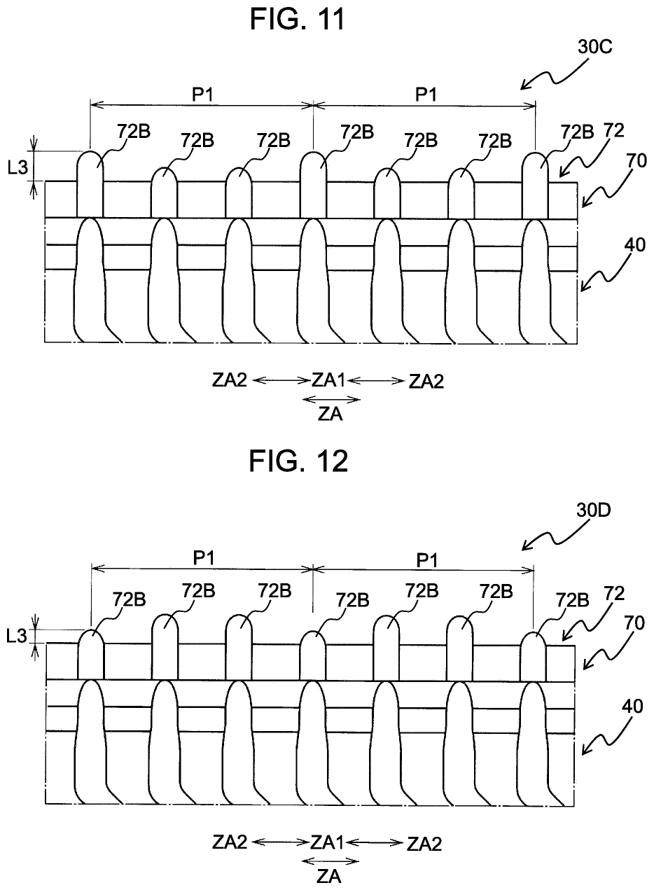

Protruding portion 72B having larger protruding dimension L3 and protruding portion 72B having smaller protruding dimension L3 are alternately placed, in a plan view. FIG. 11 is a plan view showing a structure of slit blade block 30C in accordance with a third modified example of the exemplary embodiment. FIG. 12 is a plan view showing a structure of slit blade block 30D in accordance with a fourth modified example of the exemplary embodiment.

As shown in FIG. 11, in slit blade block 30C, protruding portions 72B each having a larger protruding dimension L3 that is a distance between side surface 71B and top 72D (see FIGS. 6 and 7) are arranged at a predetermined arrangement pitch (interval P1).

As shown in FIG. 12, in slit blade block 30D, protruding portions 72B each having a smaller protruding dimension L3 that is a distance between side surface 71B and top 72D (see FIGS. 6 and 7) are arranged at interval P1.

As shown in FIGS. 2 to 4, slit outer blade 40 is mounted on comb component 60 such that linking part 43 is brought into contact with the end surface in the tip direction ZC1 of protruding portion 83. The end surface in the base direction ZC2 of end wall main body 81 is brought into contact with the surface in the tip direction ZC1 of the mount part 92 of outer blade joint 90. The end surface in base direction ZC2 of protruding portion 83 is brought into contact with the surface in the tip direction ZC1 of mount part 92.

The end surface in the width direction ZA of linking part 43 faces a surface directed to inner width direction ZA1 of comb end wall 80 via a fine gap in the width direction ZA. When accommodation part 82 accommodates protruding portion 93, comb component 60 is bonded to outer blade joint 90.

In this way, in comb component 60, protruding portion 83 is sandwiched between slit outer blade 40 and outer blade joint 90 in the height direction ZC and the width direction ZA. Thus, comb component 60 does not easily move toward slit outer blade 40 and outer blade joint 90 in the height direction ZC and the width direction ZA.

Four first claw pieces 51 are inserted into four through-holes 74A of first accommodation parts 74, respectively (see FIG. 2). Second claw piece 52 of slit outer blade 40 is inserted into through-hole 75A of second accommodation part 75 (see FIG. 2).

As shown in FIGS. 2 and 6, four positioning parts 76 are fitted into four fitting parts 53, respectively. In this state, upper regulating surface 76A and lower regulating surface 76B of positioning part 76 are accommodated in fitting part 53. Lower regulating surface 76B faces the inner surface of through-hole 53A of fitting part 53 via a fine gaps in the height direction ZC.

Position relation between a large number of outer blade pieces 41 and comb 72 is described with reference to FIG. 6.

Tip surface 72C is positioned in the tip direction ZC1 with respect to base surface 41B. Tip surface 72C is positioned in the base direction ZC2 with respect to tip surface 41A. Tip surface 41A is an end surface in the tip direction ZC1 of each of the large number of outer blade pieces 41. Base surface 41B is an end surface in the base direction ZC2 of each of the large number of outer blade pieces 41.

Top 72D is positioned slightly in the base direction ZC2 with respect to base surface 41B of outer blade piece 41. Height dimension L1 is smaller than a thickness dimension L2 of outer blade piece 41. The thickness dimension L2 is a distance between tip surface 41A and base surface 41B.

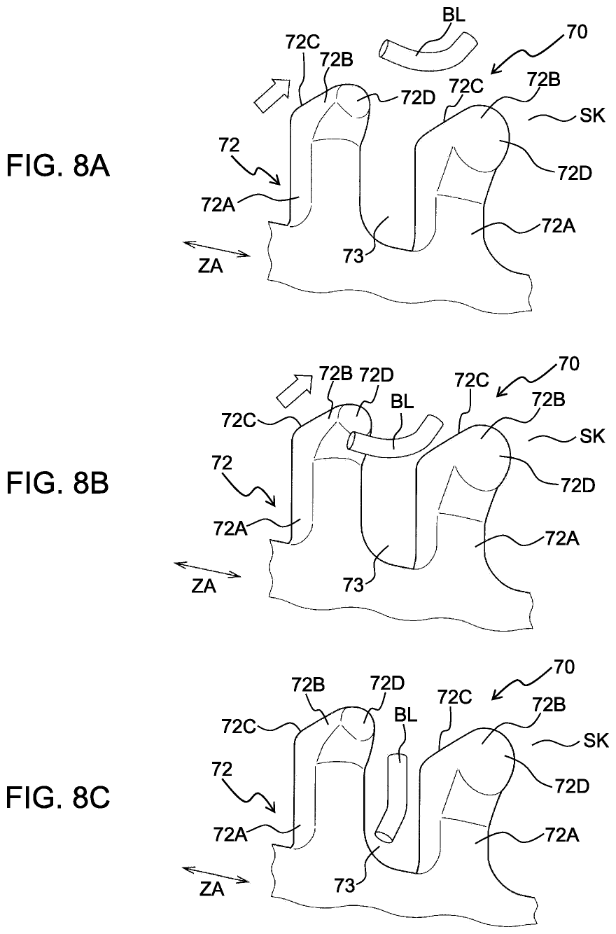

Action of comb 72 is described with reference to FIGS. 8A to 8C. FIGS. 8A to 8C are perspective views of a portion of comb 72.

As shown in FIG. 8A, top 72D is inserted between lying long facial hair BL and skin SK. Thus, as shown in FIG. 8B, long facial hair BL moves onto top 72D. As comb 72 moves, long facial hair BL rises along the surface of comb 72. As shown in FIG. 8C, long facial hair BL in a rising state is inserted into slit hole 73.

Electric shaver 1 of this exemplary embodiment has the following advantages.

(1) Slit blade block 30 includes slit outer blade 40 having a large number of outer blade pieces 41, slit inner blade 100 having a large number of inner blade pieces 102, and comb 72 provided outside slit outer blade 40. Comb 72 includes a large number of protruding portions 72B protruding in a direction away from slit outer blade 40. The plurality of protruding portions 72B includes a plurality of types of protruding portions 72B having different shapes.

Comb 72 is placed at the end portion in the tip direction ZC1 of supporting wall main body 71. The plurality of protruding portions 72B is placed at equal intervals in the width direction ZA. The more the types of protruding portions 72B are, the more hair including lying facial hair and curly facial hair can be scooped. As a result, electric shaver 1 of this exemplary embodiment can improve introducibility of hair, that is, ease of taking in hair into slit blade block 30.

(2) The plurality of types of protruding portions 72B having different shapes includes two types of protruding portions 72B having a first height dimension or a second height dimension. The first height dimension and the second height dimension are height dimensions L1 in the height direction ZC of slit blade block 30. The second height dimension is larger than the first height dimension.

The shorter a distance between the skin surface and top 72D is, the more easily lying facial hair can be scooped. Protruding portions 72B having smaller height dimension L1 introduce hair being more distant from the skin surface from top 72D into slit blade block 30 along protruding portions 72B as comb 72 moves. Protruding portion 72B having larger height dimension L1 pushes down facial hair such as lying facial hair closer to the skin surface from top 72D, and does not introduce the facial hair into slit blade block 30.

Consequently, as the height dimension L1 is smaller, the more facial hair can be introduced into slit blade block 30. However, protruding portion 72B having larger height dimension L1 can have larger curvature of top 72D. That is to say, protruding portion 72B having larger height dimension L1 has better skin contact feeling.

Electric shaver 1 of this exemplary embodiment uses comb 72 having a plurality of types of protruding portions 72B having different height dimensions L1. In other words, comb 72 has two types of two types of protruding portions 72B of which height dimension L1 is a first height dimension or a second height dimension, which is larger than the first height dimension. Thus, electric shaver 1 of this exemplary embodiment can improve introducibility of hair with irritation to the skin suppressed.

(3) The plurality of types of protruding portions 72B having different shapes include two types of protruding portions 72B having a first protruding dimension or a second protruding dimension. The first protruding dimension and the second protruding dimension are protruding dimensions L3 in the direction away from slit outer blade 40. The second protruding dimension is larger than the first protruding dimension.

In order to scoop long curly facial hair, an interval between two protruding portions 72B is preferably long. However, when the interval is too long, the number of protruding portions 72B is reduced, so that facial hair that can be scooped is reduced. Therefore, comb 72 has protruding portions 72B having a plurality of types of different protruding dimensions L3, that is, different dimensions between side surface 71B and top 72D.

In electric shaver 1 of this exemplary embodiment, protruding portions 72B having smaller protruding dimension L3 (the first protruding dimension) does not interfere, and protruding portions 72B having larger protruding dimension L3 (the second protruding dimension) scoops long facial hair. Thus, the introducibility of hair can be improved. In this exemplary embodiment, the number of protruding portion 72B can be also maintained.

(4) In protruding portion 72B having smaller protruding dimension L3, that is protruding portion 72B having the first protruding dimension, protruding dimension L3 in the direction away from the slit outer blade is larger than the height dimension L1 in the height direction of the slit blade block (see FIG. 7). In other words, in protruding portion 72B having the first protruding dimension, protruding dimension L3 is larger than the height dimension L1.

When protruding dimension L3 of protruding portion 72B having smaller height dimension L1 is too small, protruding portion 72B cannot scoop facial hair. That is to say, a certain degree of protruding dimension L3 is needed. Too small protruding portion 72B makes it difficult to manufacture comb 72.

In electric shaver 1 of this exemplary embodiment, comb 72 includes protruding portion 72B in which protruding dimension L3 is larger than height dimension L1. Thus, comb 72 capable of being manufactured easily and scooping more facial hair can be made.

(5) Height dimension L1 of protruding portions 72B having smaller protruding dimension L3 is smaller than height dimension L1 of protruding portions 72B having larger protruding dimension L3 (see FIG. 7). In other words, height dimension L1 of protruding portions 72B having the first protruding dimension is smaller than height dimension L1 of protruding portions 72B having the second protruding dimension

When protruding dimension L3 of protruding portion 72B having smaller height dimension L1 is too large, irritation to the skin by protruding portion 72B becomes stronger. In electric shaver 1 of this exemplary embodiment, comb 72 includes a plurality of types of protruding portions 72B having different protruding dimensions L3.

Specifically, height dimension L1 of protruding portion 72B having smaller protruding dimension L3 is smaller than height dimension L1 of protruding portion 72B having larger protruding dimension L3. In this exemplary embodiment, protruding portion 72B having larger height dimension L1 suppresses irritation to the skin, and protruding portion 72B having smaller height dimension L1 allows lying facial hair to rise. As a result, suppression of the irritation to the skin and improvement of the introducibility of hair can be achieved.

(6) Protruding portions 72B having larger protruding dimension L3 and protruding portions 72B having smaller protruding dimension L3 are alternately arranged. In other words, protruding portions 72B having the first protruding dimension and protruding portions 72B having the second protruding dimension are alternately arranged.

Electric shaver 1 of this exemplary embodiment can suppress irritation to the skin, and introduce curly facial hair and lying facial hair into slit blade block 30 efficiently. Electric shaver 1 of this exemplary embodiment can introduce facial hair into slit blade block 30 equally in any places in the longitudinal direction of slit blade block 30.

(7) Protruding portions 72B having larger protruding dimension L3 may be arranged at interval P1 (see FIG. 11). In other words, protruding portions 72B having the second protruding dimension are arranged at interval P1.

Electric shaver 1 of this exemplary embodiment can scoop lying long facial hair which has not been able to be scooped by conventional technology, by arranging protruding portions 72B having larger protruding dimension L3 at equal intervals.

(8) Protruding portions 72B having smaller protruding dimension L3 may be arranged at interval P1 (see FIG. 12). In other words, protruding portions 72B having the first protruding dimension are arranged at interval P1.

In electric shaver 1 of this exemplary embodiment, by arranging protruding portions 72B having smaller protruding dimension L3 at interval P1, irritation to the skin can be suppressed by protruding portion 72B having larger protruding dimension L3, while lying long facial hair can be efficiently introduced.

What is claimed is:

1. A slit blade block comprising:
a slit outer blade having a plurality of outer blade pieces;
a slit inner blade having a plurality of inner blade pieces; and
a comb provided outside the slit outer blade,
wherein the comb has a plurality of protruding portions protruding in a direction away from the slit outer blade, and
the plurality of protruding portions includes a plurality of types of protruding portions having different shapes.

2. The slit blade block according to claim 1, wherein the plurality of types of protruding portions having different shapes includes two types of protruding portions having a first height dimension or a second height dimension,
wherein the first height dimension and the second height dimension are height dimensions in a height direction of the slit blade block, and the second height dimension is larger than the first height dimension.

3. The slit blade block according to claim 2, wherein the plurality of types of protruding portions having different shapes includes two types of protruding portions having a first protruding dimension or a second protruding dimension,
wherein the first protruding dimension and the second protruding dimension are protruding dimensions in the direction away from the slit outer blade, and the second protruding dimension is larger than the first protruding dimension.

4. The slit blade block according to claim 3, wherein in protruding portions having the first protruding dimension, the protruding dimension in the direction away from the slit outer blade is larger than the height dimension in the height direction of the slit blade block.

5. The slit blade block according to claim 3, wherein the height dimension of protruding portions having the first protruding dimension is smaller than the height dimension of protruding portions having the second protruding dimension.

6. The slit blade block according to claim 3, wherein protruding portions having the first protruding dimension and protruding portions having the second protruding dimension are alternately arranged.

7. The slit blade block according to claim 3, wherein protruding portions having the second protruding dimension are arranged at predetermined intervals.

8. The slit blade block according to claim 3, wherein protruding portions having the first protruding dimension are arranged at predetermined intervals.

9. An electric shaver comprising the slit blade block according to claim 1.
